(19) United States
(12) Patent Application Publication
(10) Pub. No.: US 2024/0194435 A1
(43) Pub. Date: Jun. 13, 2024

(54) X-RAY SOURCE WITH ANODE EXCHANGE ARRANGEMENT, AND ASSOCIATED METHOD

(71) Applicant: NCX Corporation, Raleigh, NC (US)

(72) Inventor: Jian ZHANG, Durham, NC (US)

(21) Appl. No.: 18/554,873

(22) PCT Filed: Apr. 12, 2022
(86) PCT No.: PCT/IB2022/053441

§ 371 Date: Oct. 11, 2023

Related U.S. Application Data
(60) Provisional application No. 63/173,758, filed on Apr. 12, 2021.

(51) Int. Cl. H01J 35/10; H01J 35/26; H01J 35/28

(52) U.S. Cl. CPC H01J 35/10; H01J 35/26; H01J 35/28

(57) ABSTRACT

An X-ray source device includes a cathode arrangement including a cathode device arranged to emit an electron beam therefrom. An anode arrangement includes an anode spaced apart from the cathode device at a focal distance and arranged to receive the electron beam from the cathode device at one of a plurality of focal spots thereon. The anode is movable such that each of the focal spots is alignable to receive the electron beam, in some instances while maintaining the focal distance of the anode from the cathode device. An associated method of forming an X-ray source device is also provided.

### BACKGROUND

### Field of the Disclosure

The present application relates to X-ray devices and, more particularly, to an X-ray source implementing an anode exchange arrangement, and a method of forming such an X-ray source.

### Description of Related Art

A typical X-ray tube includes a cathode and an anode (see, e.g., FIG. 1), wherein the cathode (e.g., a hot filament emitter, a field emission emitter, etc.) is actuated to emit electrons in the form of a beam. The anode carries a relatively high voltage (e.g., 10 kV or more). Under these conditions, the electrons emitted by the cathode are accelerated by the electric field generated by the anode, and are attracted to and directed toward to the anode (e.g., as an electron beam). Upon the electrons impacting the anode (e.g., at a focal spot or focal point on the anode), X-ray radiation is generated via the impact/interaction between the electron beam and the anode. Generally, an X-ray tube has a single cathode emitting a single electron beam and a single anode. Therefore, the anode typically defines only a single focal spot or focal point of the electron beam, which usually corresponds to a fixed area on the anode (e.g., the area of the anode impacted by the electron beam).

During the electron beam-anode interaction, only about 1% of the electron energy is converted to X-ray energy. The remaining 99% of the electron energy is generally converted to thermal energy which heats the anode. When an anode is heated, the area on the anode directly impacted by the electrons (e.g., a focal spot) will experience the highest rise in temperature. As such, it is often critical to properly manage the thermal load of anode for an X-ray tube in order to mitigate the risk of damage to the anode (e.g., crystallization, cracking, melting) during operation of the X-ray tube. Because of the high voltage carried by such an X-ray anode (e.g., up to a few hundred kilovolts) during operation, damage to the anode may occur due to, for example, high voltage arcing. Once the anode is compromised, the entire X-ray tube is likely to be rendered useless, and thus could be very costly to be replaced. That is, such an X-ray tube is generally operated under extreme operating conditions. Accordingly, among all the possible failure modes, anode failure is one of the most likely failure mode. Should anode failure occur, then such failure risks rendering the entire X-ray tube useless.

Thus, there exists a need for an X-ray beam source and method of forming the same that is capable of compensating for damage to or inoperability of an anode for an X-ray tube, such that the X-ray tube can continue to be operable if failure of the anode is experienced (e.g., the anode is “reusable”), and thereby increase the service life of the X-ray tube. Such a solution should be readily implemented with minimal down-time, while being cost-effective to lower the operating cost of the X-ray tube.

### SUMMARY OF THE DISCLOSURE

The above and other needs are met by aspects of the present disclosure which includes, without limitation, the following example embodiments and, in one particular aspect, provides an X-ray source device includes a cathode arrangement including a cathode device arranged to emit an electron beam therefrom. An anode arrangement includes an anode spaced apart from the cathode device at a focal distance and arranged to receive the electron beam from the cathode device at one of a plurality of focal spots thereon. The anode is movable such that each of the focal spots is alignable to receive the electron beam.

Another example aspect provides a method of forming an X-ray source device, comprising arranging an anode of an anode arrangement in spaced apart relation from a cathode device of a cathode arrangement and at a focal distance thereof, such that the anode receives an electron beam emitted from the cathode device at one of a plurality of focal spots thereon: and arranging the anode to be movable such that each of the focal spots is alignable to receive the electron beam.

The present disclosure thus includes, without limitation, the following example embodiments:
Example Embodiment 1: An X-ray source device, comprising a cathode arrangement including a cathode device arranged to emit an electron beam therefrom: and an anode arrangement including an anode spaced apart from the cathode device at a focal distance thereof and arranged to receive the electron beam from the cathode device at one of a plurality of focal spots thereon, the anode being movable such that each of the focal spots is alignable to receive the electron beam.
Example Embodiment 2: The device of any preceding example embodiment, or combinations thereof, wherein the anode is movable so as to maintain the focal distance of each of the focal spots of the anode from the cathode device.
Example Embodiment 3: The device of any preceding example embodiment, or combinations thereof, wherein the anode includes an elongate member defining a longitudinal axis and having a planar surface extending parallel to the longitudinal axis, wherein the focal spots are arranged on the planar surface in a linear series parallel to the longitudinal axis, and wherein the elongate member is arranged with the longitudinal axis perpendicular to the electron beam and to be movable along the longitudinal axis such that each focal spot is alignable to receive the electron beam.
Example Embodiment 4: The device of any preceding example embodiment, or combinations thereof, wherein the anode includes an elongate member defining a longitudinal axis and having a plurality of planar surfaces defining a perimeter thereof, each planar surface extending parallel to the longitudinal axis and having one of the focal spots thereon, and wherein the elongate member is arranged with the longitudinal axis perpendicular to the electron beam and to be rotatable about the longitudinal axis such that each focal spot about the perimeter is alignable to receive the electron beam.
Example Embodiment 5: The device of any preceding example embodiment, or combinations thereof, wherein at least two of the plurality of planar surfaces comprise different materials forming the respective focal spots, the different materials having different spectral characteristics.
Example Embodiment 6: The device of any preceding example embodiment, or combinations thereof, wherein the different materials comprise copper, molybdenum, tungsten, or combinations thereof.
Example Embodiment 7: The device of any preceding example embodiment, or combinations thereof, wherein the anode includes an elongate cylindrical member defining a longitudinal axis and having a cylindrical surface extending parallel to the longitudinal axis, wherein the focal spots are arranged on the cylindrical surface in a linear series parallel to the longitudinal axis, and wherein the elongate cylindrical member is arranged with the longitudinal axis perpendicular to the electron beam and to be movable along the longitudinal axis such that each focal spot is alignable to receive the electron beam.
Example Embodiment 8: The device of any preceding example embodiment, or combinations thereof, wherein the anode includes an elongate cylindrical member defining a longitudinal axis and having a cylindrical surface defining a perimeter thereof, the cylindrical surface extending parallel to the longitudinal axis and having the focal spots extending about the perimeter in a plane perpendicular to the longitudinal axis, and wherein the elongate cylindrical member is arranged with the longitudinal axis perpendicular to the electron beam and to be rotatable about the longitudinal axis such that each focal spot about the perimeter is alignable to receive the electron beam.
Example Embodiment 9: The device of any preceding example embodiment, or combinations thereof, wherein the cathode arrangement is arranged to emit a plurality of parallel electron beams therefrom, wherein the anode includes an elongate member defining a longitudinal axis and having a planar surface extending parallel to the longitudinal axis, wherein the focal spots are arranged on the planar surface in a linear series parallel to the longitudinal axis, the linear series including a plurality of subsets, with each subset including a plurality of the focal spots corresponding to the plurality of parallel electron beams, and wherein the elongate member is arranged with the longitudinal axis perpendicular to the plurality of electron beams and to be movable along the longitudinal axis such that the focal spots in each subset are alignable to receive the corresponding plurality of parallel electron beams.
Example Embodiment 10: The device of any preceding example embodiment, or combinations thereof, wherein the cathode arrangement is arranged to emit a plurality of parallel electron beams therefrom, wherein the anode includes an elongate member defining a longitudinal axis and having a plurality of planar surfaces defining a perimeter thereof, each planar surface extending parallel to the longitudinal axis and having a subset of the focal spots thereon corresponding to the plurality of parallel electron beams, and wherein the elongate member is arranged with the longitudinal axis perpendicular to the plurality of electron beams and to be rotatable about the longitudinal axis such that each subset of focal spots about the perimeter is alignable to receive the corresponding plurality of parallel electron beams.
Example Embodiment 11: The device of any preceding example embodiment, or combinations thereof, wherein at least two of the plurality of planar surfaces comprise different materials forming the respective focal spots, the different materials having different spectral characteristics.
Example Embodiment 12: The device of any preceding example embodiment, or combinations thereof, wherein the different materials comprise copper, molybdenum, tungsten, or combinations thereof.
Example Embodiment 13: The device of any preceding example embodiment, or combinations thereof, wherein the anode arrangement comprises a stepper actuator in communication with the anode, the stepper actuator being arranged to move the anode along the longitudinal axis thereof or to rotate the anode about the longitudinal axis.
Example Embodiment 14: The device of any preceding example embodiment, or combinations thereof, wherein the anode includes a rotational axis and has a plurality of planar surfaces defining a perimeter of the anode, each planar surface extending at a different oblique angle relative and non-parallel to the rotational axis and having one of the focal spots thereon, and wherein the anode is arranged with the rotational axis perpendicular to the electron beam and to be rotatable about the rotational axis such that each focal spot about the perimeter is alignable to receive the electron beam and to emit X-rays in response thereto, the X-rays emitted from each planar surface having a dispersion corresponding to the oblique angle of the planar surface such that each planar surface provides a different field of view.
Example Embodiment 15: The device of any preceding example embodiment, or combinations thereof, wherein the anode includes a rotational axis and has a plurality of planar surfaces defining a perimeter of the anode, each planar surface extending at a same oblique angle relative and non-parallel to the rotational axis and having one of the focal spots thereon, and wherein the anode is arranged with the rotational axis perpendicular to the electron beam and to be rotatable about the rotational axis such that each focal spot about the perimeter is alignable to receive the electron beam and to emit X-rays in response thereto, such that the emitted X-rays are directed in opposing directions from each planar surface.
Example Embodiment 16: The device of any preceding example embodiment, or combinations thereof, wherein the anode includes a rotational axis and has a plurality of planar surfaces defining a perimeter of the anode, each planar surface extending parallel to and being displaced at a different distance from the rotational axis and having one of the focal spots thereon, wherein the anode is arranged with the rotational axis perpendicular to the electron beam and to be rotatable about the rotational axis such that each focal spot about the perimeter is alignable to receive the electron beam and is disposed at a different focal distance from the cathode device, and such that X-rays emitted from each planar surface in response to the electron beam at different focal lengths provides a different viewing perspective.
Example Embodiment 17: The device of any preceding example embodiment, or combinations thereof, wherein each planar surface at a different focal length from the cathode device interacts with the electron beam over a different size of the respective focal spot, and the emitted X-rays have imaging characteristics corresponding to the different sizes of the focal spots.
Example Embodiment 18: A method of forming an X-ray source device, comprising arranging an anode of an anode arrangement in spaced apart relation from a cathode device of a cathode arrangement and at a focal distance thereof, such that the anode receives an electron beam emitted from the cathode device at one of a plurality of focal spots thereon: and arranging the anode to be movable such that each of the focal spots is alignable to receive the electron beam.
Example Embodiment 19: The method of any preceding example embodiment, or combinations thereof, wherein arranging the anode to be movable comprises arranging the anode to be movable while maintaining the focal distance of the anode from the cathode device.
Example Embodiment 20: The method of any preceding example embodiment, or combinations thereof, wherein the anode includes an elongate member defining a longitudinal axis and having a planar surface extending parallel to the longitudinal axis, and wherein the method comprises arranging the focal spots on the planar surface in a linear series parallel to the longitudinal axis.
Example Embodiment 21: The method of any preceding example embodiment, or combinations thereof, wherein arranging the anode to be movable comprises arranging the elongate member with the longitudinal axis perpendicular to the electron beam and to be movable along the longitudinal axis such that each focal spot is alignable to receive the electron beam.
Example Embodiment 22: The method of any preceding example embodiment, or combinations thereof, wherein the anode includes an elongate member defining a longitudinal axis and having a plurality of planar surfaces defining a perimeter thereof, and wherein the method comprises arranging the elongate member such that each planar surface extends parallel to the longitudinal axis thereof and has one of the focal spots thereon.
Example Embodiment 23: The method of any preceding example embodiment, or combinations thereof, wherein arranging the anode to be movable comprises arranging the elongate member with the longitudinal axis perpendicular to the electron beam and to be rotatable about the longitudinal axis such that each focal spot about the perimeter is alignable to receive the electron beam.
Example Embodiment 24: The method of any preceding example embodiment, or combinations thereof, comprising arranging the anode such that at least two of the plurality of planar surfaces comprise different materials forming the respective focal spots, the different materials having different spectral characteristics.
Example Embodiment 25: The method of any preceding example embodiment, or combinations thereof, wherein arranging the anode comprises arranging the anode such that the different materials comprise copper, molybdenum, tungsten, or combinations thereof.
Example Embodiment 26: The method of any preceding example embodiment, or combinations thereof, wherein the anode includes an elongate cylindrical member defining a longitudinal axis and having a cylindrical surface extending parallel to the longitudinal axis, and wherein the method comprises arranging the focal spots on the cylindrical surface in a linear series parallel to the longitudinal axis.
Example Embodiment 27: The method of any preceding example embodiment, or combinations thereof, wherein arranging the anode to be movable comprises arranging the elongate cylindrical member with the longitudinal axis perpendicular to the electron beam and to be movable along the longitudinal axis such that each focal spot is alignable to receive the electron beam.
Example Embodiment 28: The method of any preceding example embodiment, or combinations thereof, wherein the anode includes an elongate cylindrical member defining a longitudinal axis and having a cylindrical surface defining a perimeter thereof, the cylindrical surface extending parallel to the longitudinal axis, and wherein the method comprises arranging the focal spots to extending about the perimeter of the elongate member in a plane perpendicular to the longitudinal axis.
Example Embodiment 29: The method of any preceding example embodiment, or combinations thereof, wherein arranging the anode to be movable comprises arranging the elongate cylindrical member with the longitudinal axis perpendicular to the electron beam and to be rotatable about the longitudinal axis such that each focal spot about the perimeter is alignable to receive the electron beam.
Example Embodiment 30: The method of any preceding example embodiment, or combinations thereof, wherein the cathode arrangement is arranged to emit a plurality of parallel electron beams therefrom, wherein the anode includes an elongate member defining a longitudinal axis and having a planar surface extending parallel to the longitudinal axis, and wherein the method comprises arranging the focal spots on the planar surface in a linear series parallel to the longitudinal axis, the linear series including a plurality of subsets, with each subset including a plurality of the focal spots corresponding to the plurality of parallel electron beams.
Example Embodiment 31: The method of any preceding example embodiment, or combinations thereof, wherein arranging the anode to be movable comprises arranging the elongate member with the longitudinal axis perpendicular to the plurality of electron beams and to be movable along the longitudinal axis such that the focal spots in each subset are alignable to receive the corresponding plurality of parallel electron beams.
Example Embodiment 32: The method of any preceding example embodiment, or combinations thereof, wherein the cathode arrangement is arranged to emit a plurality of parallel electron beams therefrom, wherein the anode includes an elongate member defining a longitudinal axis and having a plurality of planar surfaces defining a perimeter thereof, each planar surface extending parallel to the longitudinal axis, and wherein the method comprises arranging a subset of the focal spots on each planar surface, the subset corresponding to the plurality of parallel electron beams.
Example Embodiment 33: The method of any preceding example embodiment, or combinations thereof, wherein arranging the elongate member to be movable comprises arranging the elongate member with the longitudinal axis perpendicular to the plurality of electron beams and to be rotatable about the longitudinal axis such that each subset of focal spots about the perimeter is alignable to receive the corresponding plurality of parallel electron beams.
Example Embodiment 34: The method of any preceding example embodiment, or combinations thereof, comprising arranging the anode such that at least two of the plurality of planar surfaces comprise different materials forming the respective focal spots, the different materials having different spectral characteristics.
Example Embodiment 35: The method of any preceding example embodiment, or combinations thereof, wherein arranging the anode comprises arranging the anode such that the different materials comprise copper, molybdenum, tungsten, or combinations thereof.
Example Embodiment 36: The method of any preceding example embodiment, or combinations thereof, wherein the anode arrangement comprises a stepper actuator in communication with the anode, and wherein the method comprises arranging the stepper actuator to move the anode along the longitudinal axis thereof or to rotate the anode about the longitudinal axis.
Example Embodiment 37: The method of any preceding example embodiment, or combinations thereof, wherein the anode includes a rotational axis and has a plurality of planar surfaces defining a perimeter of the anode, each planar surface extending at a different oblique angle relative and non-parallel to the rotational axis and having one of the focal spots thereon, and wherein the method comprises arranging the anode with the rotational axis perpendicular to the electron beam and to be rotatable about the rotational axis such that each focal spot about the perimeter is alignable to receive the electron beam and to emit X-rays in response thereto, the X-rays emitted from each planar surface having a dispersion corresponding to the oblique angle of the planar surface such that each planar surface provides a different field of view.
Example Embodiment 38: The method of any preceding example embodiment, or combinations thereof, wherein the anode includes a rotational axis and has a plurality of planar surfaces defining a perimeter of the anode, each planar surface extending at a same oblique angle relative and non-parallel to the rotational axis and having one of the focal spots thereon, and wherein the method comprises arranging the anode with the rotational axis perpendicular to the electron beam and to be rotatable about the rotational axis such that each focal spot about the perimeter is alignable to receive the electron beam and to emit X-rays in response thereto such that the emitted X-rays are directed in opposing directions from each planar surface.
Example Embodiment 39: The method of any preceding example embodiment, or combinations thereof, wherein the anode includes a rotational axis and has a plurality of planar surfaces defining a perimeter of the anode, each planar surface extending parallel to and being displaced at a different distance from the rotational axis and having one of the focal spots thereon, and wherein the method comprises arranging the anode with the rotational axis perpendicular to the electron beam and to be rotatable about the rotational axis such that each focal spot about the perimeter is alignable to receive the electron beam and is disposed at a different focal distance from the cathode device, and such that X-rays emitted from each planar surface in response to the electron beam at different focal lengths provides a different viewing perspective.
Example Embodiment 40: The method of any preceding example embodiment, or combinations thereof, wherein arranging the anode with the rotational axis perpendicular to the electron beam and to be rotatable about the rotational axis comprises arranging the anode with the rotational axis perpendicular to the electron beam and to be rotatable about the rotational axis such that each planar surface at a different focal length from the cathode device interacts with the electron beam over a different size of the respective focal spot, and the emitted X-rays have imaging characteristics corresponding to the different sizes of the focal spots.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as intended, namely to be combinable, unless the context of the disclosure clearly dictates otherwise.

It will be appreciated that the summary herein is provided merely for purposes of summarizing some example aspects so as to provide a basic understanding of the disclosure. As such, it will be appreciated that the above described example aspects are merely examples and should not be construed to narrow the scope or spirit of the disclosure in any way. It will be appreciated that the scope of the disclosure encompasses many potential aspects, some of which will be further described below, in addition to those herein summarized. Further, other aspects and advantages of such aspects disclosed herein will become apparent from the following detailed description taken in conjunction with the accompanying drawings which illustrate, by way of example, the principles of the described aspects.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 schematically illustrates a prior art example of an X-ray source structure including a single cathode and a single stationary anode:

FIGS. 2A-2C schematically illustrate an X-ray source structure including a single cathode and a single anode, according to one aspect of the present disclosure, wherein the anode is an elongate member having a linear series of focal spots thereon, and wherein the elongate member is axially movable such that each of the focal spots in the linear series is alignable to receive the electron beam emitted from the cathode device:

FIGS. 3A and 3B schematically illustrate an X-ray source structure including a single cathode and a single anode, according to one aspect of the present disclosure, wherein the anode is an elongate member having a plurality of planar surfaces defining a perimeter thereof, with each planar surface having a focal spot thereon, and wherein the elongate member is rotatable about the longitudinal axis such that each focal spot about the perimeter is alignable to receive the electron beam:

FIG. 4A schematically illustrates an X-ray source structure including a single cathode and a single anode, according to one aspect of the present disclosure, wherein the anode is an elongate cylindrical member having a linear series of focal spots on a cylindrical surface thereof, and wherein the elongate cylindrical member is axially movable such that each focal spot in the linear series is alignable to receive the electron beam:

FIG. 4B schematically illustrates an X-ray source structure including a single cathode and a single anode, according to one aspect of the present disclosure, wherein the anode is an elongate cylindrical member having focal spots extending about a perimeter of a cylindrical surface thereof in a plane perpendicular to the longitudinal axis, and wherein the elongate cylindrical member is rotatable about the axis such that each focal spot in the linear series is alignable to receive the electron beam:

FIG. 5A schematically illustrates an X-ray source structure including a cathode arrangement emitting a plurality of parallel electron beams therefrom, according to one aspect of the present disclosure, wherein the anode is an elongate member having a plurality of focal spot subsets on a planar surface thereof, each subset including a linear series of focal spots corresponding to the plurality of parallel electron beams, and wherein the elongate member is axially movable such that the focal spots in each subset are alignable to receive the corresponding plurality of parallel electron beams:

FIG. 5B schematically illustrates an X-ray source structure including a cathode arrangement emitting a plurality of parallel electron beams therefrom, according to one aspect of the present disclosure, wherein the anode is an elongate member having a focal spot subset on each of a plurality of planar surfaces defining a perimeter of the elongate member, each subset including focal spots corresponding to the plurality of parallel electron beams, and wherein the elongate member is rotatable about the longitudinal axis such that each subset of focal spots about the perimeter is alignable to receive the corresponding plurality of parallel electron beams:

FIGS. 6A and 6B schematically illustrate an X-ray source structure including a single cathode and a single anode, according to one aspect of the present disclosure, wherein the anode includes an elongate member defining a longitudinal axis and having a plurality of planar surfaces defining a perimeter thereof, with each planar surface extending parallel to the longitudinal axis and having one of the focal spots thereon, wherein the elongate member is rotatable about the longitudinal axis such that each focal spot about the perimeter is alignable to receive the electron beam, and wherein at least two of the plurality of planar surfaces comprise different materials forming the respective focal spots, the different materials having different spectral characteristics.

FIGS. 7A and 7B schematically illustrate an X-ray source structure including a single cathode and a single anode, according to one aspect of the present disclosure, wherein the anode includes a rotational axis and has a plurality of planar surfaces defining a perimeter of the anode, with each planar surface extending at a different oblique angle relative and non-parallel to the rotational axis and having one of the focal spots thereon, and wherein the anode is rotatable about the rotational axis such that each focal spot about the perimeter is alignable to receive the electron beam and to emit X-rays in response thereto, with the X-rays emitted from each planar surface having a dispersion corresponding to the oblique angle of the planar surface such that each planar surface provides a different field of view:

FIGS. 8A and 8B schematically illustrate an X-ray source structure including a single cathode and a single anode, according to one aspect of the present disclosure, wherein the anode includes a rotational axis and has a plurality of planar surfaces defining a perimeter of the anode, with each planar surface extending at a same oblique angle relative and non-parallel to the rotational axis and having one of the focal spots thereon, and wherein the anode is rotatable about the rotational axis such that each focal spot about the perimeter is alignable to receive the electron beam and to emit X-rays in response thereto, such that the emitted X-rays are directed in opposing directions from each planar surface.

FIGS. 9A-9C schematically illustrate an X-ray source structure including a single cathode and a single anode, according to one aspect of the present disclosure, wherein the anode includes a rotational axis and has a plurality of planar surfaces defining a perimeter of the anode, with each planar surface extending parallel to and being displaced at a different distance from the rotational axis and having one of the focal spots thereon, wherein the anode is rotatable about the rotational axis such that each focal spot about the perimeter is alignable to receive the electron beam and is disposed at a different focal distance from the cathode device, and such that X-rays emitted from each planar surface in response to the electron beam at different focal lengths provides a different viewing perspective.

FIG. 10 schematically illustrates a method of forming an X-ray source device, according to one aspect of the present disclosure.

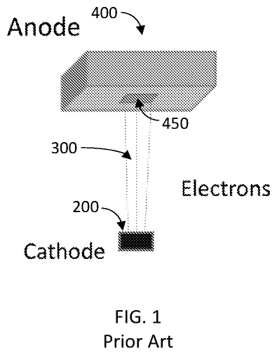

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein: rather, these aspects are provided so that this disclosure will satisfy applicable legal requirements. Like numbers refer to like elements throughout.

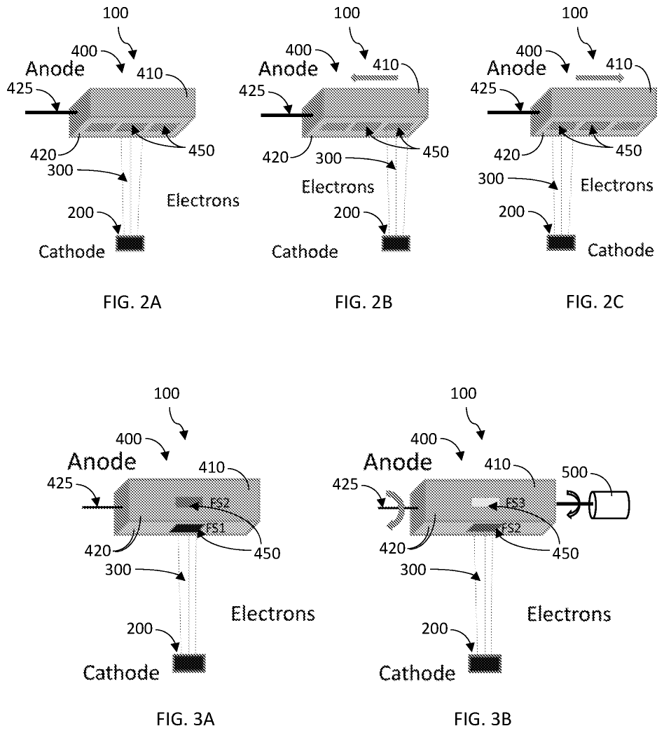

FIGS. 2A-2C, 3A, 3B, 4A, 4B, 5A, and 5B schematically illustrate aspects of an X-ray source structure or device 100, according to various aspects of the present disclosure. In some aspects, the X-ray source device 100 includes a cathode arrangement including a cathode device 200 arranged to emit an electron beam 300 therefrom. An anode arrangement includes an anode 400 spaced apart from the cathode device 200 at a focal distance thereof, wherein the anode 400 is arranged to receive the electron beam 300 from the cathode device 200 at one of a plurality of focal spots 450 thereon. In particular aspects, the anode 400 is movable such that each of the focal spots 450 is alignable to receive the electron beam 300. In other particular aspects, the anode 400 is movable such that each of the focal spots 450 is alignable to receive the electron beam 300, while maintaining the focal distance of the anode 400 from the cathode device 200.

The spare/redundant focal spots 450 on the anode 400, with the anode 400 being movable such that the spare focal spots 450 are movable into alignment with the electron beam 300 emitted by the cathode device 200 thus allows the X-ray source device 100, for example, to compensate for damage to or inoperability of one of the focal spots (i.e., if one of the focal spots is compromised in some manner) on the anode 400 of an X-ray tube. That is, by moving the anode 400 such that another focal spot 450 is aligned with the electron beam 300 (and such that the substitute focal point 450 is at the focal distance of the anode 400 from the cathode device 200), upon realizing damage to or inoperability of (e.g., anode failure) another focal spot thereon, the X-ray tube can continue to be operable with minimal down-time. The anode 400 can thus be considered to be “reusable” or to have redundant focal spots 450, thereby increasing the service life of the X-ray tube. Such a solution can be readily implemented with minimal down-time of the X-ray tube, thereby being cost-effective to lower the operating cost of the X-ray tube.

In particular aspects as shown, for example, in FIGS. 2A-2C, the anode 400 includes an elongate member 410 defining a longitudinal axis 425. The elongate member 410 further includes a planar surface 420 extending parallel to the longitudinal axis 425 thereof. The focal spots 450 are arranged on the planar surface 420 in a linear series parallel to the longitudinal axis 425. The elongate member 410 is further arranged with the longitudinal axis 425 perpendicular to the electron beam 300 emitted by the cathode device 200. As shown, the elongate member 410 is arranged to be movable along the longitudinal axis 425 thereof such that each focal spot 450 is alignable to receive the electron beam 300. For example, if the central portion of the elongate member 410 is pre-conditioned to be used as the primary focal spot 450 (FIG. 2A), and that focal spot 450 becomes compromised (e.g., inoperable), the elongate member 410 can be moved in either direction along the longitudinal axis 425 thereof such that the next focal spot 450 in the linear series is aligned with the electron beam 300 emitted by the cathode device 200 (FIGS. 2B and 2C), wherein each of the focal spots 450 result from the same preconditioning of the anode surface.

In another aspect as shown, for example, in FIGS. 3A and 3B, the anode 400 includes an elongate member 410 defining a longitudinal axis 425. The elongate member 410 further includes a plurality of planar surfaces 420 cooperating with each other to define a perimeter of the elongate member 410, wherein each planar surface 420 extends parallel to the longitudinal axis 425 thereof. Each planar surface 420 further includes one of the focal spots 450 thereon, wherein the focal spots 450 on the planar surfaces 420 are disposed in a plane extending perpendicularly to the longitudinal axis 425 of the elongate member 410. The elongate member 410 is further arranged with the longitudinal axis 425 perpendicular to the electron beam 300 emitted by the cathode device 200. As shown, the elongate member 410 is also arranged to be rotatable about the longitudinal axis 425 such that each focal spot 450 about the perimeter is alignable to receive the electron beam 300. For example, if one planar surface 420 has a portion pre-conditioned to be used as the primary focal spot 450 (FS1 in FIG. 3A), and that focal spot 450 becomes compromised (e.g., inoperable), the elongate member 410 can be rotated about the longitudinal axis 425 thereof such that the focal spot 450 on the next planar surface 420 is aligned with the electron beam 300 emitted by the cathode device 200 (e.g., FS2 in FIG. 3A or FS3 in FIG. 3B), wherein each of the focal spots 450 lies in the plane perpendicular to the longitudinal axis 425 and result from the same preconditioning of the respective planar surface 420 to form that focal spot 450.

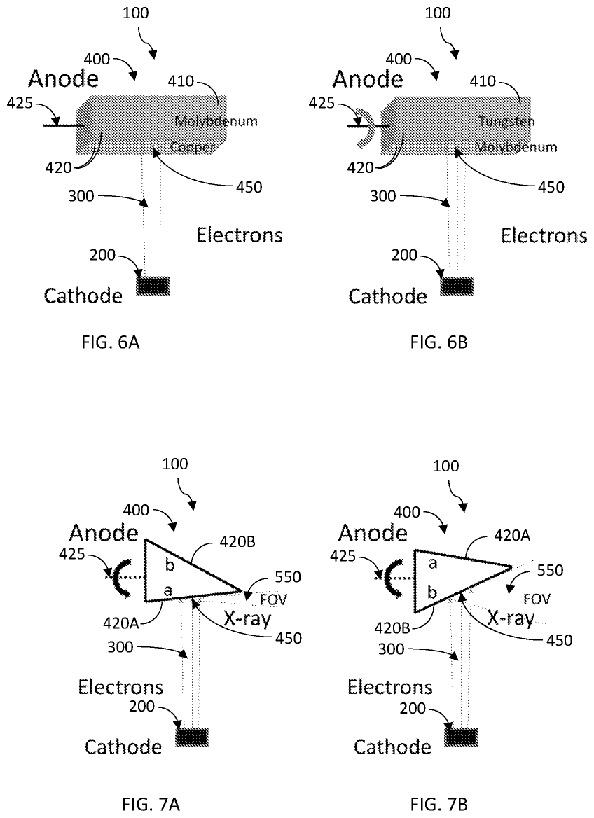

In some aspects, as shown for example in FIGS. 6A and 6B, at least two of the plurality of planar surfaces 420 of the embodiment shown in FIG. 3B can comprise different materials forming the respective focal spots 450, wherein the different materials have different spectral characteristics. For example, the at least two planar surfaces 420 can be comprised of, coated with, or otherwise include different materials such as copper, molybdenum, tungsten, or combinations thereof. That is, as shown in FIGS. 6A and 6B, each planar surface/side 420 of the anode 400 may be made of different materials for X-ray generation in response to the electron beam. Example materials may include copper, molybdenum, tungsten, other appropriate X-ray generation material, or combinations thereof. The X-ray generated from each different planar surface 420/focal spot 450 having the different X-ray generation material may have different X-ray spectral characteristics, thus facilitating implementation in various X-ray spectral imaging applications.

One skilled in the art will further appreciate that, if necessary or desired, the aspects disclosed in FIGS. 2A-2C may be incorporated into the aspects disclosed in FIGS. 3A and 3B. That is, each planar surface 420 shown in FIGS. 3A and 3B can include a linear series of the focal spots 450 thereon. Accordingly, for example, the elongate member 410 (anode 400) can be movable along the longitudinal axis 425 and rotatable about the longitudinal axis 425 so as to provide additional spare focal points or focal spots 450 with which to maintain operability of the X-ray source device 100.

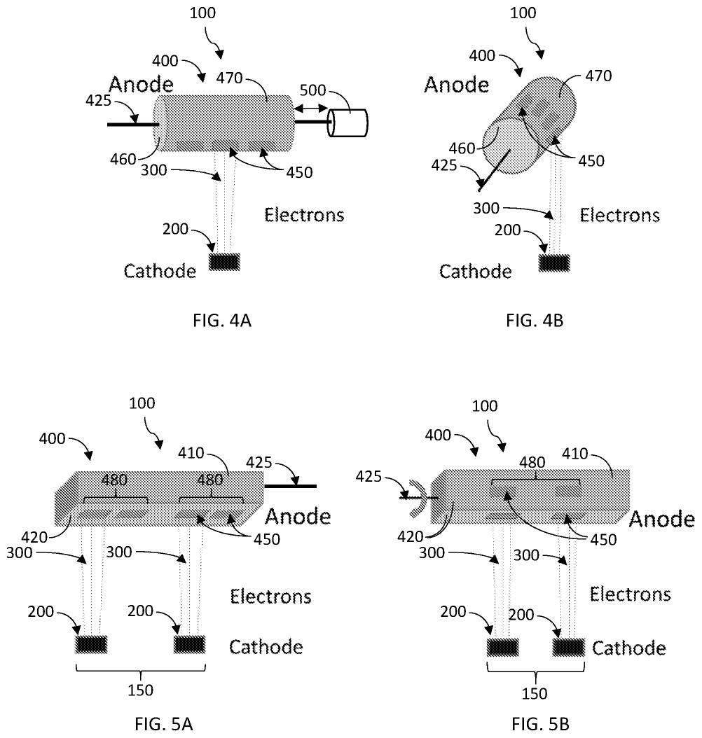

In yet another aspect, as shown in FIG. 4A, the anode 400 includes an elongate cylindrical member 460 defining a longitudinal axis 425. The elongate cylindrical member 460 further includes and defines a cylindrical surface 470 extending parallel to the longitudinal axis 425. In one particular aspect, the focal spots 450 are arranged on the cylindrical surface 470 in a linear series parallel to the longitudinal axis 425. The elongate cylindrical member 460 is further arranged with the longitudinal axis 425 perpendicular to the electron beam 300 emitted by the cathode device 200. As shown, the elongate cylindrical member 460 is arranged to be movable along the longitudinal axis 425 thereof such that each focal spot 450 is alignable to receive the electron beam 300. For example, if the central portion of the elongate cylindrical member 460 is pre-conditioned to be used as the primary focal spot 450 (FIG. 4A), and that focal spot 450 becomes compromised (e.g., inoperable), the elongate cylindrical member 460 can be moved in either direction along the longitudinal axis 425 thereof such that the next focal spot 450 in the linear series is aligned with the electron beam 300 emitted by the cathode device 200, wherein each of the focal spots 450 result from the same preconditioning of the cylindrical anode surface 470.

In still another aspect as shown, for example, in FIG. 4B, the anode 400 includes an elongate cylindrical member 460 defining a longitudinal axis 425. The elongate cylindrical member 460 further includes and defines a cylindrical surface 470 extending parallel to the longitudinal axis 425, with the cylindrical surface 470 defining a perimeter or circumference of elongate cylindrical member 460. The cylindrical surface 470 has the focal spots 450 extending about the perimeter of the elongate cylindrical member 460 each in a plane perpendicular to the longitudinal axis 425. The elongate cylindrical member 460 is further arranged with the longitudinal axis 425 perpendicular to the electron beam 300 emitted by the cathode device 200. As shown, the elongate cylindrical member 460 is also arranged to be rotatable about the longitudinal axis 425 such that each focal spot 450 about the perimeter is alignable to receive the electron beam 300. For example, if the cylindrical surface 470 has a portion pre-conditioned to be used as the primary focal spot 450, and that focal spot 450 becomes compromised (e.g., inoperable), the elongate cylindrical member 460 can be rotated about the longitudinal axis 425 thereof such that the next focal spot 450 on the cylindrical surface 470 is aligned with the electron beam 300 emitted by the cathode device 200 (see, e.g., FIG. 4B), wherein each of the focal spots 450 lies in the plane perpendicular to the longitudinal axis 425 and result from the same preconditioning of the cylindrical surface 470 to form that focal spot 450.

One skilled in the art will further appreciate that, if necessary or desired, the aspects disclosed in FIG. 4A may be incorporated into the aspects disclosed in FIG. 4B. That is, the cylindrical surface 470 can include a linear series of the focal spots 450 thereon, as shown, for example, in FIG. 4A, but the linear series can be repeated about the perimeter or circumference of the elongate cylindrical member 470. Accordingly, for example, the elongate cylindrical member 460 (anode 400) can be movable along the longitudinal axis 425 and rotatable about the longitudinal axis 425 so as to provide additional spare focal points 450 with which to maintain operability of the X-ray source device 100.

In some aspects, the cathode arrangement (see, e.g., element 150 in FIGS. 5A and 5B) is arranged to have a plurality of cathode devices 200 arranged to emit a plurality of (e.g., multiple) parallel electron beams 300 therefrom, and the provisions disclosed herein can also be extended to such multiple electron beam configurations. For example, as shown in FIG. 5A, the anode 400 includes an elongate member 410 defining a longitudinal axis 425. The elongate member further includes a planar surface 420 extending parallel to the longitudinal axis 425 thereof. The focal spots 450 are arranged on the planar surface 420 in a linear series parallel to the longitudinal axis 425. Each linear series including a plurality of subsets 480, with each subset 480 including a plurality of the focal spots 450 corresponding to the plurality of parallel electron beams 300. That is, as shown in FIG. 5A, if the cathode arrangement 150 emits two electron beams 300, each subset 480 will include two focal spots 450 corresponding to the two electron beams 300. The elongate member 410 is further arranged with the longitudinal axis 425 perpendicular to the plurality of electron beams 300 emitted by the cathode arrangement 150. As shown, the elongate member 410 is arranged to be movable along the longitudinal axis 425 thereof such that focal spots 450 in each subset 480 are alignable to receive the corresponding plurality of parallel electron beams 300.

In another aspect as shown, for example, in FIG. 5B, the cathode arrangement 150 is arranged to emit a plurality of (e.g., multiple) parallel electron beams 300 therefrom. In such aspects, the anode 400 includes an elongate member 410 defining a longitudinal axis 425. The elongate member 410 further includes a plurality of planar surfaces 420 cooperating with each other to define a perimeter of the elongate member 410, wherein each planar surface 420 extends parallel to the longitudinal axis 425 thereof. Each planar surface 420 further includes a subset 480 of the focal spots 450 thereon corresponding to the plurality of parallel electron beams 300. The elongate member 410 is further arranged with the longitudinal axis 425 perpendicular to the electron beams 300 emitted by the cathode arrangement 150. As shown, the elongate member 410 is also arranged to be rotatable about the longitudinal axis 425 such that each subset 480 of focal spots 450 about the perimeter is alignable to receive the corresponding plurality of parallel electron beams 300. As previously addressed, in some aspects, as shown for example in FIGS. 6A and 6B, at least two of the plurality of planar surfaces 420 of the embodiment shown in FIG. 5B can comprise different materials forming the respective focal spots 450, wherein the different materials have different spectral characteristics. One skilled in the art will further appreciate that, if necessary or desired, the aspects disclosed in FIG. 5A may be incorporated into the aspects disclosed in FIG. 5B. That is, each planar surface 420 shown in FIG. 5B can include a linear series of the focal spots 450 thereon, with each linear series including a plurality of subsets 480, and with each subset 480 including a plurality of the focal spots 450 corresponding to the plurality of parallel electron beams 300. Accordingly, for example, the elongate member 410 (anode 400) can be movable along the longitudinal axis 425 and rotatable about the longitudinal axis 425 so as to provide additional spare focal points 450 with which to maintain operability of the multi-electron beam X-ray source device 100.

During operation of the electron beam X-ray source device, the surface (or portion of the surface) of the anode 400 facing the cathode device 200 and bombarded by the electron beam 300 generated from the cathode device 200 can become overheated. However, implementation of the multiple pre-conditioned focal spots 450 on the planar surfaces/sides 420 or on the cylindrical surface 470 of the anode 400, the anode 400 can be rotated and/or transversely displaced (shifted) in order to expose other separate/spaced apart focal spots 450 to the electron beam 300 instead. By regulating the thermal condition of the anode 400 in this manner, continuous or at least semi-continuous operation of the electron beam X-ray source device 100 can be achieved, instead of suspending operation of the X-ray source device 100 to allow the anode 400 to cool down before resuming operation. The usage/duty cycle of such an X-ray source device 100 can therefore be increased, while decreasing or eliminating the risk of thermal damage to the anode 400 during operation of the X-ray source device 100.

In some aspects, in order to translate the anode 400 along the longitudinal axis 425 and/or to rotate the anode about the longitudinal axis 425, the anode arrangement comprises a stepper actuator (see, e.g., element 500 in FIGS. 3B and 4A) in communication with the anode 400. In such aspects, the stepper actuator 500 is arranged to move the anode 400 along the longitudinal axis 425 thereof and/or to rotate the anode 400 about the longitudinal axis 425, while maintaining the focal distance of the anode 425 from the cathode device 200.

In another aspect of the present disclosure, as shown for example in FIGS. 7A and 7B, the anode 400 is arranged to include a rotational axis 425 and a plurality of planar surfaces (e.g., elements 420A, 420B) defining a perimeter of the anode 400. In such instances, each planar surface 420A, 420B extends at a different oblique angle relative and non-parallel to the rotational axis 425 and has at least one of the focal spots 450 thereon. The anode 400 is further arranged with the rotational axis 425 perpendicular to the electron beam 300 and to be rotatable about the rotational axis 425 such that each focal spot about the perimeter of the anode 400 is alignable to receive the electron beam 300 and to emit X-rays 550 in response thereto. The X-rays 550 emitted from each planar surface 420A, 420B have a dispersion corresponding to the oblique angle of the particular planar surface 420A, 420B such that each planar surface provides a different field of view. For example, the magnitude of the oblique angle may be proportional to the magnitude of the field of view such that the greater the oblique angle, the greater the field of view. That is, each planar surface/side 420A, 420B of the anode 400 may be arranged at a different oblique angle in relation to the rotational axis 425. As such, when the anode 400 is rotated to have illustrated planar surface 420B, instead of planar surface 420A, facing the cathode device 200, the greater oblique angle of planar surface 420B provide a wider or greater field of view (FOV) of the X-ray source device 100 for X-ray imaging applications. One skilled in the art will appreciate, however, that the anode 400 could also take different forms such as, for example, a skewed cone with different focal spots about the perimeter thereof, which could provide finer incremental tuning of the magnitude of the field of view, as described.

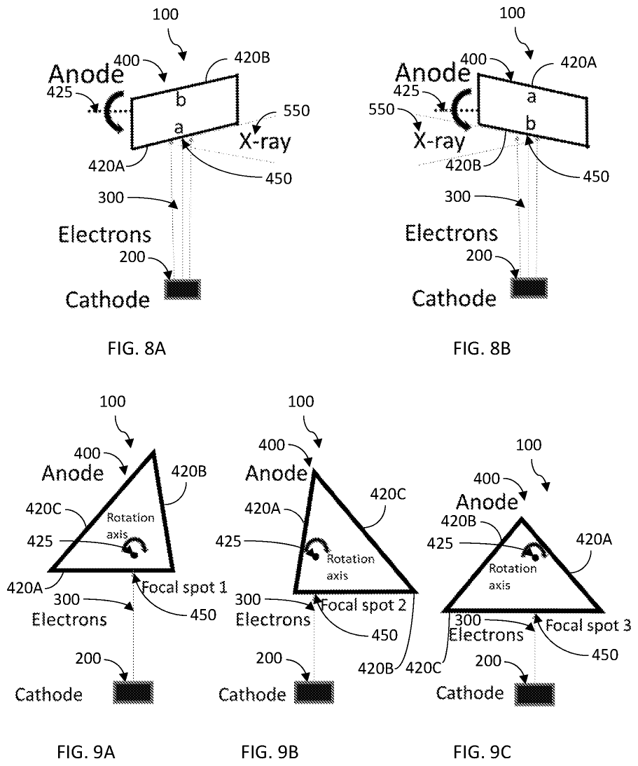

In another aspect of the present disclosure, as shown for example in FIGS. 8A and 8B, the anode 400 is arranged to include a rotational axis 425 and has a plurality of planar surfaces (see, e.g., elements 420A and 420B) defining a perimeter of the anode 400. In such instances, each planar surface 420A, 420B extends at a same oblique angle relative and non-parallel to the rotational axis 425 and has at least one of the focal spots 450 thereon. The anode 400 is arranged with the rotational axis 425 perpendicular to the electron beam 300 and to be rotatable about the rotational axis 425 such that each focal spot 450 about the perimeter is alignable to receive the electron beam 300 and to emit X-rays 550 in response thereto. The X-rays 550 emitted from each planar surface 420A, 420B are directed in opposing directions from each planar surface 420A, 420B, as illustrated in FIGS. 9A and 9B. That is, the opposed planar surfaces 420A, 420B are disposed at the same oblique angle in relation to the rotational axis 425 such that the X-rays 550 generated by the electron beam 300 interaction with the anode 400 are directed in opposing directions, since the rotation of the anode 400 from planar surface 420A to planar surface 420B reverses the angular orientation of the focal spots 450. One skilled in the art will appreciate, however, that the anode 400 could also take different forms such as, for example, a skewed cylinder with different focal spots about the perimeter thereof.

In another aspect of the present disclosure, as shown for example in FIGS. 9A-9C, the anode 400 is arranged to include a rotational axis 425 and has a plurality of planar surfaces (see, e.g., 420A, 420B, 420C) defining a perimeter of the anode 400. In such instances, each planar surface 420A, 420B, 420C extends parallel to and is displaced at a different distance from the rotational axis 425 and has at least one of the focal spots 450 thereon. The anode 400 is arranged with the rotational axis 425 perpendicular to the electron beam 300 and to be rotatable about the rotational axis 425 such that each focal spot 450 about the perimeter is alignable to receive the electron beam 300 and such that each focal spot 450 is disposed at a different focal distance from the cathode device 200. The X-rays 550 thus emitted from each planar surface 420A, 420B, 420C in response to the electron beam 300 at the different focal lengths provides a different viewing perspective. That is, each planar surface/side 420A, 420B, 420C of the anode 400 having a focal spot 450 may be arranged to spaced apart from the cathode device 200 at different distance. By rotating the anode 400 between the different planar surfaces 420A, 420B, 420C, the physical location of the focal spot changes in space, which can facilitate the obtention of multiple images of an examined object from different viewing perspectives (e.g., angles in relation to the object), without requiring movement or rotation of the entire X-ray source device 100.

Further, the anode 400 shown in FIGS. 9A-9C is arranged such that each planar surface 420A, 420B, 420C is at a different focal length from the cathode device 200 and each interacts with the electron beam 300 over or across a different size of the respective focal spot 450. The emitted X-rays thus have imaging characteristics corresponding to the different sizes of the focal spots 450. That is, the focal spot 450 on each planar surface/side 420A, 420B, 420C of the anode 400 may have a different focal spot size due to the difference in focal distance from the cathode device 200, the condition or surface configuration of each planar surface 420A, 420B, 420C, or other factors. Focal spots 450 of different sizes may in some instances be suitable and appropriate for different X-ray applications. For example, large focal spots 450 may be useful for low resolution, high-power X-ray applications, while small focal spots 450 may be useful for high resolution, low power X-ray applications.

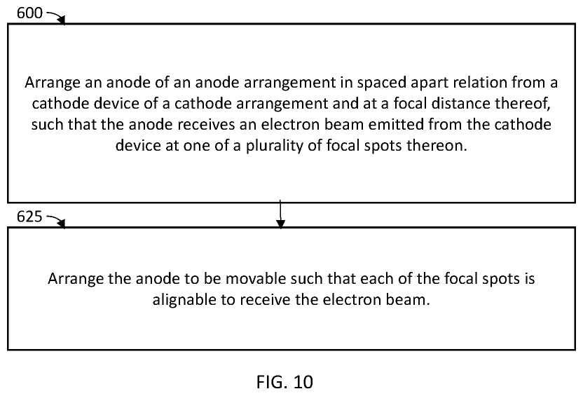

Another aspect of the present disclosure, as shown in FIG. 10, includes a method of forming an X-ray source device. Such a method comprises arranging an anode of an anode arrangement in spaced apart relation from a cathode device of a cathode arrangement and at a focal distance thereof, such that the anode receives an electron beam emitted from the cathode device at one of a plurality of focal spots thereon (Block 600). The anode is arranged to be movable such that each of the focal spots is alignable to receive the electron beam (Block 625).

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

That which is claimed:

1. An X-ray source device, comprising:
a cathode arrangement including a cathode device arranged to emit an electron beam therefrom; and
an anode arrangement including an anode spaced apart from the cathode device at a focal distance thereof and arranged to receive the electron beam from the cathode device at one of a plurality of focal spots thereon, the anode being movable such that each of the focal spots is alignable to receive the electron beam.

2. The device of claim 1, wherein the anode is movable so as to maintain the focal distance of each of the focal spots of the anode from the cathode device.

3. The device of claim 2, wherein the anode includes an elongate member defining a longitudinal axis and having a planar surface extending parallel to the longitudinal axis, wherein the focal spots are arranged on the planar surface in a linear series parallel to the longitudinal axis, and wherein the elongate member is arranged with the longitudinal axis perpendicular to the electron beam and to be movable along the longitudinal axis such that each focal spot is alignable to receive the electron beam.

4. The device of claim 2, wherein the anode includes an elongate member defining a longitudinal axis and having a plurality of planar surfaces defining a perimeter thereof, each planar surface extending parallel to the longitudinal axis and having one of the focal spots thereon, and wherein the elongate member is arranged with the longitudinal axis perpendicular to the electron beam and to be rotatable about the longitudinal axis such that each focal spot about the perimeter is alignable to receive the electron beam.

5. The device of claim 4, wherein at least two of the plurality of planar surfaces comprise different materials forming the respective focal spots, the different materials having different spectral characteristics.

6. The device of claim 5, wherein the different materials comprise copper, molybdenum, tungsten, or combinations thereof.

7. The device of claim 2, wherein the anode includes an elongate cylindrical member defining a longitudinal axis and having a cylindrical surface extending parallel to the longitudinal axis, wherein the focal spots are arranged on the cylindrical surface in a linear series parallel to the longitudinal axis, and wherein the elongate cylindrical member is arranged with the longitudinal axis perpendicular to the electron beam and to be movable along the longitudinal axis such that each focal spot is alignable to receive the electron beam.

8. The device of claim 2, wherein the anode includes an elongate cylindrical member defining a longitudinal axis and having a cylindrical surface defining a perimeter thereof, the cylindrical surface extending parallel to the longitudinal axis and having the focal spots extending about the perimeter in a plane perpendicular to the longitudinal axis, and wherein the elongate cylindrical member is arranged with the longitudinal axis perpendicular to the electron beam and to be rotatable about the longitudinal axis such that each focal spot about the perimeter is alignable to receive the electron beam.

9. The device of claim 2, wherein the cathode arrangement is arranged to emit a plurality of parallel electron beams therefrom, wherein the anode includes an elongate member defining a longitudinal axis and having a planar surface extending parallel to the longitudinal axis, wherein the focal spots are arranged on the planar surface in a linear series parallel to the longitudinal axis, the linear series including a plurality of subsets, with each subset including a plurality of the focal spots corresponding to the plurality of parallel electron beams, and wherein the elongate member is arranged with the longitudinal axis perpendicular to the plurality of electron beams and to be movable along the longitudinal axis such that the focal spots in each subset are alignable to receive the corresponding plurality of parallel electron beams.

10. The device of claim 2, wherein the cathode arrangement is arranged to emit a plurality of parallel electron beams therefrom, wherein the anode includes an elongate member defining a longitudinal axis and having a plurality of planar surfaces defining a perimeter thereof, each planar surface extending parallel to the longitudinal axis and having a subset of the focal spots thereon corresponding to the plurality of parallel electron beams, and wherein the elongate member is arranged with the longitudinal axis perpendicular to the plurality of electron beams and to be rotatable about the longitudinal axis such that each subset of focal spots about the perimeter is alignable to receive the corresponding plurality of parallel electron beams.

11. The device of claim 10, wherein at least two of the plurality of planar surfaces comprise different materials forming the respective focal spots, the different materials having different spectral characteristics.

12. The device of claim 11, wherein the different materials comprise copper, molybdenum, tungsten, or combinations thereof.

13. The device of claim 2, wherein the anode arrangement comprises a stepper actuator in communication with the anode, the stepper actuator being arranged to move the anode along the longitudinal axis thereof or to rotate the anode about the longitudinal axis.

14. The device of claim 1, wherein the anode includes a rotational axis and has a plurality of planar surfaces defining a perimeter of the anode, each planar surface extending at a different oblique angle relative and non-parallel to the rotational axis and having one of the focal spots thereon, and wherein the anode is arranged with the rotational axis perpendicular to the electron beam and to be rotatable about the rotational axis such that each focal spot about the perimeter is alignable to receive the electron beam and to emit X-rays in response thereto, the X-rays emitted from each planar surface having a dispersion corresponding to the oblique angle of the planar surface such that each planar surface provides a different field of view.

15. The device of claim 1, wherein the anode includes a rotational axis and has a plurality of planar surfaces defining a perimeter of the anode, each planar surface extending at a same oblique angle relative and non-parallel to the rotational axis and having one of the focal spots thereon, and wherein the anode is arranged with the rotational axis perpendicular to the electron beam and to be rotatable about the rotational axis such that each focal spot about the perimeter is alignable to receive the electron beam and to emit X-rays in response thereto, such that the emitted X-rays are directed in opposing directions from each planar surface.

16. The device of claim 1, wherein the anode includes a rotational axis and has a plurality of planar surfaces defining a perimeter of the anode, each planar surface extending parallel to and being displaced at a different distance from the rotational axis and having one of the focal spots thereon, wherein the anode is arranged with the rotational axis perpendicular to the electron beam and to be rotatable about the rotational axis such that each focal spot about the perimeter is alignable to receive the electron beam and is disposed at a different focal distance from the cathode device, and such that X-rays emitted from each planar surface in response to the electron beam at different focal lengths provides a different viewing perspective.

17. The device of claim 16, wherein each planar surface at a different focal length from the cathode device interacts with the electron beam over a different size of the respective focal spot, and the emitted X-rays have imaging characteristics corresponding to the different sizes of the focal spots.

18. A method of forming an X-ray source device, comprising:
arranging an anode of an anode arrangement in spaced apart relation from a cathode device of a cathode arrangement and at a focal distance thereof, such that the anode receives an electron beam emitted from the cathode device at one of a plurality of focal spots thereon; and
arranging the anode to be movable such that each of the focal spots is alignable to receive the electron beam.

19. The method of claim 18, arranging the anode to be movable comprises arranging the anode to be movable while maintaining the focal distance of the anode from the cathode device

20. The method of claim 19, wherein the anode includes an elongate member defining a longitudinal axis and having a planar surface extending parallel to the longitudinal axis, and wherein the method comprises arranging the focal spots on the planar surface in a linear series parallel to the longitudinal axis.

21. The method of claim 20, wherein arranging the anode to be movable comprises arranging the elongate member with the longitudinal axis perpendicular to the electron beam and to be movable along the longitudinal axis such that each focal spot is alignable to receive the electron beam.

22. The method of claim 19, wherein the anode includes an elongate member defining a longitudinal axis and having a plurality of planar surfaces defining a perimeter thereof, and wherein the method comprises arranging the elongate member such that each planar surface extends parallel to the longitudinal axis thereof and has one of the focal spots thereon.

23. The method of claim 22, wherein arranging the anode to be movable comprises arranging the elongate member with the longitudinal axis perpendicular to the electron beam and to be rotatable about the longitudinal axis such that each focal spot about the perimeter is alignable to receive the electron beam.

24. The method of claim 23, comprising arranging the anode such that at least two of the plurality of planar surfaces comprise different materials forming the respective focal spots, the different materials having different spectral characteristics.

25. The method of claim 24, wherein arranging the anode comprises arranging the anode such that the different materials comprise copper, molybdenum, tungsten, or combinations thereof.

26. The method of claim 19, wherein the anode includes an elongate cylindrical member defining a longitudinal axis and having a cylindrical surface extending parallel to the longitudinal axis, and wherein the method comprises arranging the focal spots on the cylindrical surface in a linear series parallel to the longitudinal axis.

27. The method of claim 26, wherein arranging the anode to be movable comprises arranging the elongate cylindrical member with the longitudinal axis perpendicular to the electron beam and to be movable along the longitudinal axis such that each focal spot is alignable to receive the electron beam.

28. The method of claim 19, wherein the anode includes an elongate cylindrical member defining a longitudinal axis and having a cylindrical surface defining a perimeter thereof, the cylindrical surface extending parallel to the longitudinal axis, and wherein the method comprises arranging the focal spots to extending about the perimeter of the elongate member in a plane perpendicular to the longitudinal axis.

29. The method of claim 28, wherein arranging the anode to be movable comprises arranging the elongate cylindrical member with the longitudinal axis perpendicular to the electron beam and to be rotatable about the longitudinal axis such that each focal spot about the perimeter is alignable to receive the electron beam.

30. The method of claim 19, wherein the cathode arrangement is arranged to emit a plurality of parallel electron beams therefrom, wherein the anode includes an elongate member defining a longitudinal axis and having a planar surface extending parallel to the longitudinal axis, and wherein the method comprises arranging the focal spots on the planar surface in a linear series parallel to the longitudinal axis, the linear series including a plurality of subsets, with each subset including a plurality of the focal spots corresponding to the plurality of parallel electron beams.

31. The method of claim 30, wherein arranging the anode to be movable comprises arranging the elongate member with the longitudinal axis perpendicular to the plurality of electron beams and to be movable along the longitudinal axis such that the focal spots in each subset are alignable to receive the corresponding plurality of parallel electron beams.

32. The method of claim 19, wherein the cathode arrangement is arranged to emit a plurality of parallel electron beams therefrom, wherein the anode includes an elongate member defining a longitudinal axis and having a plurality of planar surfaces defining a perimeter thereof, each planar surface extending parallel to the longitudinal axis, and wherein the method comprises arranging a subset of the focal spots on each planar surface, the subset corresponding to the plurality of parallel electron beams.

33. The method of claim 32, wherein arranging the elongate member to be movable comprises arranging the elongate member with the longitudinal axis perpendicular to the plurality of electron beams and to be rotatable about the longitudinal axis such that each subset of focal spots about the perimeter is alignable to receive the corresponding plurality of parallel electron beams.

34. The method of claim 33, comprising arranging the anode such that at least two of the plurality of planar surfaces comprise different materials forming the respective focal spots, the different materials having different spectral characteristics.

35. The method of claim 34, wherein arranging the anode comprises arranging the anode such that the different materials comprise copper, molybdenum, tungsten, or combinations thereof.

36. The method of claim 19, wherein the anode arrangement comprises a stepper actuator in communication with the anode, and wherein the method comprises arranging the stepper actuator to move the anode along the longitudinal axis thereof or to rotate the anode about the longitudinal axis.

37. The method of claim 18, wherein the anode includes a rotational axis and has a plurality of planar surfaces defining a perimeter of the anode, each planar surface extending at a different oblique angle relative and non-parallel to the rotational axis and having one of the focal spots thereon, and wherein the method comprises arranging the anode with the rotational axis perpendicular to the electron beam and to be rotatable about the rotational axis such that each focal spot about the perimeter is alignable to receive the electron beam and to emit X-rays in response thereto, the X-rays emitted from each planar surface having a dispersion corresponding to the oblique angle of the planar surface such that each planar surface provides a different field of view.

38. The method of claim 18, wherein the anode includes a rotational axis and has a plurality of planar surfaces defining a perimeter of the anode, each planar surface extending at a same oblique angle relative and non-parallel to the rotational axis and having one of the focal spots thereon, and wherein the method comprises arranging the anode with the rotational axis perpendicular to the electron beam and to be rotatable about the rotational axis such that each focal spot about the perimeter is alignable to receive the electron beam and to emit X-rays in response thereto such that the emitted X-rays are directed in opposing directions from each planar surface.

39. The method of claim 18, wherein the anode includes a rotational axis and has a plurality of planar surfaces defining a perimeter of the anode, each planar surface extending parallel to and being displaced at a different distance from the rotational axis and having one of the focal spots thereon, and wherein the method comprises arranging the anode with the rotational axis perpendicular to the electron beam and to be rotatable about the rotational axis such that each focal spot about the perimeter is alignable to receive the electron beam and is disposed at a different focal distance from the cathode device, and such that X-rays emitted from each planar surface in response to the electron beam at different focal lengths provides a different viewing perspective.

40. The method of claim 39, wherein arranging the anode with the rotational axis perpendicular to the electron beam and to be rotatable about the rotational axis comprises arranging the anode with the rotational axis perpendicular to the electron beam and to be rotatable about the rotational axis such that each planar surface at a different focal length from the cathode device interacts with the electron beam over a different size of the respective focal spot, and the emitted X-rays have imaging characteristics corresponding to the different sizes of the focal spots.
